(19) United States
(12) Patent Application Publication
(10) Pub. No.: US 2020/0247696 A1
(43) Pub. Date: Aug. 6, 2020

(54) INSITU REDUCTION OF HEXAVALENT CHROMIUM

(71) Applicant: HACH COMPANY, Loveland, CO (US)

(72) Inventor: Cary Burton Jackson, Fort Collins, CO (US)

(21) Appl. No.: 16/649,564

(22) PCT Filed: Sep. 28, 2018
(86) PCT No.: PCT/US18/53535

§ 371 Date: Mar. 20, 2020

Related U.S. Application Data
(60) Provisional application No. 62/564,716, filed on Sep. 28, 2017.

(51) Int. Cl. C02F 1/70; C02F 1/52

(52) U.S. Cl. CPC C02F 1/70; C02F 2101/22; C02F 1/5236

(57) ABSTRACT

An embodiment provides a method for quenching hexavalent chromium, including: obtaining a vessel comprising an aqueous sample comprising hexavalent chromium; introducing a reducing agent to the aqueous sample; and mixing, into a mixed solution, the reducing agent and the aqueous sample, wherein the mixing causes the reducing agent to quench the hexavalent chromium and wherein a quantity of the reducing agent comprises a quantity that reduces the hexavalent chromium to trivalent chromium.

### BACKGROUND

This application relates generally to the insitu reduction and quenching of hexavalent chromium.

Ensuring water quality is critical in a number of industries such as pharmaceuticals and other manufacturing fields. Additionally, ensuring water quality is critical to the health and well-being of humans, animals, and plants which are reliant on the water for survival. One method to test water quality is a chemical oxygen demand test which may create an amount of hexavalent chromium. However, hexavalent chromium is a known carcinogen.

### BRIEF SUMMARY

In summary, one embodiment provides a method for quenching hexavalent chromium, comprising: obtaining a vessel comprising an aqueous sample comprising hexavalent chromium; introducing a reducing agent to the aqueous sample; and mixing, into a mixed solution, the reducing agent and the aqueous sample, wherein the mixing causes the reducing agent to quench the hexavalent chromium and wherein a quantity of the reducing agent comprises a quantity that reduces the hexavalent chromium to trivalent chromium.

Another embodiment provides a device, comprising: a processor; a memory device that stores instructions executable by the processor to: obtain a vessel comprising an aqueous sample comprising hexavalent chromium; introduce a reducing agent to the aqueous sample; and mix, into a mixed solution, the reducing agent and the aqueous sample, wherein the mixing causes the reducing agent to quench the hexavalent chromium and wherein a quantity of the reducing agent comprises a quantity that reduces the hexavalent chromium to trivalent chromium.

A further embodiment provides a product for quenching hexavalent chromium, comprising: a storage device having code stored therewith, the code being executable by the processor and comprising: code that obtains a vessel comprising an aqueous sample comprising hexavalent chromium; code that introduces a reducing agent to the aqueous sample; and code that mixes, into a mixed solution, the reducing agent and the aqueous sample, wherein the mixing causes the reducing agent to quench the hexavalent chromium and wherein a quantity of the reducing agent comprises a quantity that reduces the hexavalent chromium to trivalent chromium.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of computer circuitry

FIG. 2 illustrates a flow diagram of quenching hexavalent chromium in an aqueous sample.

FIG. 3 illustrates a reduction reaction.

FIG. 4 illustrates a reduction reaction of hexavalent chromium to trivalent chromium.

FIG. 5 illustrates a reaction with a caustic to precipitate chromium hydroxide.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well-known structures, materials, or operations are not shown or described in detail. The following description is intended only by way of example, and simply illustrates certain example embodiments.

Using chemical oxygen demand (COD) testing for measurement of organic loading in wastewater or other solutions is very common. Chemical oxygen demand testing is a measurement of the oxygen required to oxidize the organic matter in the water. One reagent that may be used in COD testing of organic load in water is potassium dichromate or chromium trioxide. Hexavalent chromium (Cr(VI)) is the active redox agent found in both potassium dichromate and chromium trioxide.

Cr(VI) is a known carcinogen and is highly mobile in the environment. Ingestion of Cr(VI) may lead to the breakdown of DNA and lead to mutagenic damage. Consuming water containing Cr(VI) may lead to irritation of the stomach or intestines, toxicity in the liver, and even cancers of the mouth or small intestine. Breathing Cr(VI) may lead to lung malignancies including squamous cell carcinoma. The use of dichromate COD chemistry without proper safe handling, disposal, or treatment may increase Cr(VI) fugacity into the environment. Thus, governments around the world are reassessing the use of Cr(VI), even for COD testing. Currently, there are no acceptable alternatives that yield the same test results to that of dichromate-based COD.

Accordingly, an embodiment provides a system and method for quenching hexavalent chromium which converts the hexavalent chromium to the safer and environmentally friendly trivalent chromium Cr(III). Cr(III) is not a carcinogen and is even an essential human dietary element. An embodiment obtains a vessel comprising an aqueous sample comprising hexavalent chromium. For example, the vessel comprising the hexavalent chromium may be the end result of the dichromate-based COD testing.

In an embodiment a reducing agent is introduced to the aqueous sample. In an embodiment, the reducing agent may be ascorbic acid, hydrogen peroxide, sulfur dioxide, ferrous sulfate, sodium metabisulfite, or the like. The reducing agent may be in a granular, lyophilized, or aqueous form. In one embodiment, the reducing agent may be added to the vessel. Alternatively, the reducing agent may be contained in the cap of the vessel. In an embodiment the reducing agent is in a quantity to reduce the hexavalent chromium to trivalent chromium. The amount of reducing agent used may be determined by the size of the vessel, the amount of Cr(VI) in the sample, or any other means understood in the art to calculate necessary reagents for a complete reduction reaction. The reducing agent and the aqueous sample are then mixed to cause the reducing agent to quench the Cr(VI) and be reduced to Cr(III). The mixing of the solution may generate a colorimetric agent allowing visualization of a reduction reaction. Thus, in one embodiment, completion of the reduction reaction may be determined by the color of the solution.

The illustrated example embodiments will be best understood by reference to the figures. The following description is intended only by way of example, and simply illustrates certain example embodiments.

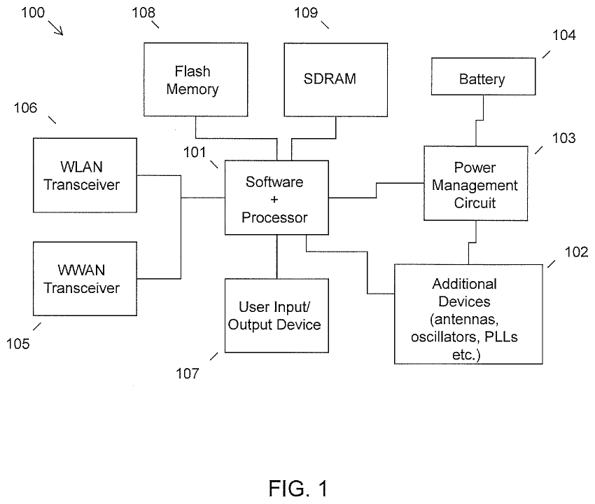

While various other circuits, circuitry or components may be utilized in information handling devices, with regard to an instrument for performing COD testing according to any one of the various embodiments described herein, an example is illustrated in FIG. 1. Device circuitry 100 may include a measurement system on a chip design found, for example, a particular computing platform (e.g., mobile computing, desktop computing, etc.) Software and processor(s) are combined in a single chip 101. Processors comprise internal arithmetic units, registers, cache memory, busses, I/O ports, etc., as is well known in the art. Internal busses and the like depend on different vendors, but essentially all the peripheral devices (102) may attach to a single chip 101. The circuitry 400 combines the processor, memory control, and I/O controller hub all into a single chip 110. Also, systems 400 of this type do not typically use SATA or PCI or LPC. Common interfaces, for example, include SDIO and I2C.

There are power management chip(s) 103, e.g., a battery management unit, BMU, which manage power as supplied, for example, via a rechargeable battery 104, which may be recharged by a connection to a power source (not shown). In at least one design, a single chip, such as 101, is used to supply BIOS like functionality and DRAM memory.

System 100 typically includes one or more of a WWAN transceiver 105 and a WLAN transceiver 106 for connecting to various networks, such as telecommunications networks and wireless Internet devices, e.g., access points. Additionally, devices 102 are commonly included, e.g., an a transmit and receive antenna, oscillators, PLLs, etc. System 100 includes input/output devices 107 for data input and display/rendering (e.g., a computing location located away from the single beam system that is easily accessible by a user). System 100 also typically includes various memory devices, for example flash memory 108 and SDRAM 109.

It can be appreciated from the foregoing that electronic components of one or more systems or devices may include, but are not limited to, at least one processing unit, a memory, and a communication bus or communication means that couples various components including the memory to the processing unit(s). A system or device may include or have access to a variety of device readable media. System memory may include device readable storage media in the form of volatile and/or nonvolatile memory such as read only memory (ROM) and/or random access memory (RAM). By way of example, and not limitation, system memory may also include an operating system, application programs, other program modules, and program data. The disclosed system may be used in an embodiment to perform COD testing that generates Cr(VI) or may be used in an embodiment to cause a reduction of Cr(VI) to Cr(III) through a reduction reaction.

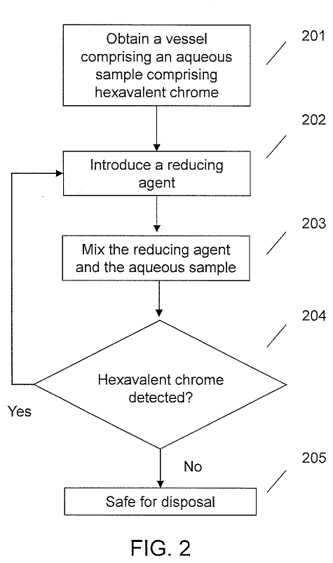

Referring now to FIG. 2, an embodiment may quench hexavalent chromium (Cr(VI)). Cr(VI) may be used as the active redox agent of potassium dichromate chromium trioxide used in chemical oxygen demand (COD) testing of organic loading in wastewater. When Cr(VI) oxidizes an organic or inorganic ion substrate found in a wastewater sample, Cr(VI) may be consumed in the reaction and reduced to trivalent chromium (Cr(III). However, not all the Cr(VI) may be consumed. Thus, resulting in residual Cr(VI) which is a known carcinogen. Additionally, Cr(VI) is highly mobile in the environment. Thus, the use of dichromate COD chemistry without proper safe handling, disposal, and/or treatment may increase Cr(VI)'s fugacity into the environment and may pose a safety threat to water analysts and consumers. Environmental risks associated with dichromate COD chemistry, which includes Cr(VI), may pose a challenge to governments and agencies searching for a more environmentally friendly method of performing COD testing. On the other hand, Cr(III) is not a known carcinogen, and is actually an essential human dietary element.

Accordingly, FIG. 2 illustrates an embodiment that provides a process for quenching Cr(VI) into safer Cr(III). An embodiment involves obtaining a vessel comprising an aqueous sample comprising Cr(VI) at 201. Obtaining a vessel may include a user inserting a vessel into an embodiment. For example, a vessel may be inserted into a machine or device that can introduce agents and/or solutions into the vessel, mix the agents with the solution, and/or measure or detect hexavalent chromium. In one embodiment, the sample may be a sample of water that was obtained from a larger water sample and subjected to COD testing. The sample may be in a vial, tube, aliquot, bottle, vessel, or the like. For ease of reading, the term vessel is used here throughout, but other types are contemplated and disclosed. The vessel may be constructed of a material such as glass, plastic, or the like. The vessel housing the sample may the same vessel that was used in the COD testing. Alternatively, the vessel housing the sample may be different from the vessel housing the sample for the COD testing. However, regardless of the vessel housing the sample, the sample will be the sample resulting from performance or completion of COD testing. In other words, the sample will include at least some amount of Cr(VI) resulting from the COD testing.

In an embodiment the vessel may have a cap. The cap may be affixed by any means to provide a seal between the cap and the vessel. For example, the cap may thread, cam-lock, snap, or the like, onto the vessel. A seal such as a disk, o-ring, gasket, or the like, may be disposed between the cap and the vessel to provide a watertight seal between the cap and the vessel. In one embodiment, the cap may include a compartment. This compartment may be on a surface continuous with the cavity formed by the vessel when the lid is secured to the vessel. For example, the compartment may directly exposed or adjacent to the cavity in the vessel when the cap is secured on the vessel. In one embodiment, the compartment in the cap may have reaction reagents, for example, reducing agents, contained therein. The reaction reagents are explained in more detail below. The reaction reagents may be contained in the cap itself, or in a container housed on a surface inside the cap. The reaction reagents in the compartment of the lid may then be mixed with an aqueous sample in the vial after the lid is securely affixed to the vial.

In an embodiment, a reducing agent may be introduced with the Cr(VI) in aqueous solution at 202. A reducing agent may be a liquid or solid. In solid form, the reducing agent may be granular form, lyophilized, or the like. The introduction of the reducing agent may include adding the reducing agent to the sample or vessel using a scoop, tablet, dropper, pipettor, syringe, or the like. A reducing agent may be introduced by personnel or by a machine. As discussed above, the reducing agent may be contained in a vial, a cap, or a combination of the vial and cap. The reducing agent may include any type or agent that can reduce Cr(VI) to Cr(III), for example, ascorbic acid, hydrogen peroxide, sulfur dioxide, ferrous sulfate, sodium metabisulfite, or the like. The quantity of reducing agent may be determined based upon a known amount of Cr(VI) to be reduced, the volume of a reaction vial, a volume of an aqueous sample, or any method understood by those in the art.

In an embodiment, a reducing agent may be mixed with the aqueous sample at 203. Mixing may include any method or technique that combines the reducing agent with the sample. For example, in the case that the reducing agent is included in the cap attached to the vessel, the sealed vessel may be shaken or rotated in order to mix the reducing agent included in the cap with the sample. As another example, in the case that the reducing agent is added to the vessel, for example, using a dropper or scoop, the reducing agent may be stirred with the sample. Alternatively, the vessel may be secured after introduction of the reducing agent and then shaken, rotated, or otherwise mixed to combine the reducing agent with the sample. The mixing may cause a reducing agent to quench the Cr(VI) to Cr(III). In other words, once the reducing agent has been mixed with the sample, the Cr(VI) included in the sample may be reduced to Cr(III). The mixing may be performed by personnel or by a mechanical device. The mixing may also include or mix other reagents necessary for a reaction in a vial.

In an embodiment, the mixing may generate a colorimetric agent that allows for visualization of a reduction reaction. This visualization may allow a user or machine to determine if hexavalent chromium is still present in the sample. Accordingly, an embodiment may determine, at 204, if hexavalent chromium is still detected at 204. A color of the solution may indicate the reduction of Cr(VI) to Cr(III). For example, sodium metabisulfite may be used as the reducing agent, and the color of the aqueous solution may change from an orange-like color in the presence of Cr(VI) to a light blue-like or dark-green color in the presence of Cr(III). The color change allows for a visual indication of the completeness of a reduction reaction. The color of the solution may be interpreted by observation, comparing the color to known colors for given reactant concentration, or may be interpreted by a machine capable of measuring the color of the solution, such as a spectrophotometer. The colorimetric agent may be introduced as a separate species in the reducing reaction, or may be generated by the reduction reaction itself. If the Cr(VI) is reduced to a desirable level as determined by the colorimetric agent, the process may be completed at 205. Accordingly, the solution may be safe for disposal at this point. If Cr(VI) is still detected at 204, then further reduction by a reducing agent may be necessary to complete the reduction of Cr(VI) to Cr(III), for example, returning to step 202.

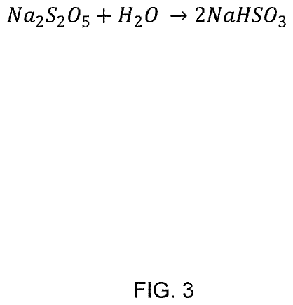

Un-reduced Cr(VI) in a vessel may be treated insitu after a COD test with a non-toxic agent such as ascorbic acid, hydrogen peroxide, sulfur dioxide, ferrous sulfate, or sodium metabisulfite. A resulting redox reaction may convert Cr(VI) to Cr(III). As an example, FIG. 3 illustrates an example reduction reaction using sodium metabisulfite as the reducing chemical or agent. A reaction using sodium metabisulfate reacts with water to form sodium bisulfite.

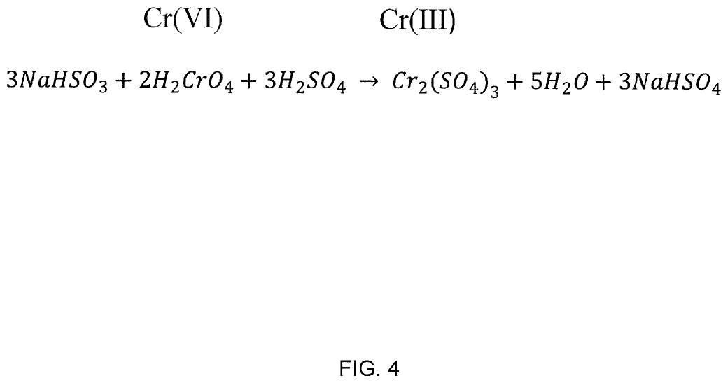

Referring to FIG. 4, Cr(VI) may be reduced to Cr(III) by a reducing agent. In an embodiment, the sodium bisulfite reacts with Cr(VI) in the presence of sulfuric acid to reduce the Cr(VI) to Cr(III), with sodium bisulfate and water as products. Introduction of sodium metabisulfite may be in an aqueous solution added to the dichromate COD vessel. Alternatively, the sodium metabisulfite may be in a granular, lyophilized, or like form. The sodium metabilsufite may be in the vessel or the cap of the vessel. Other reducing agents may be used in other embodiments.

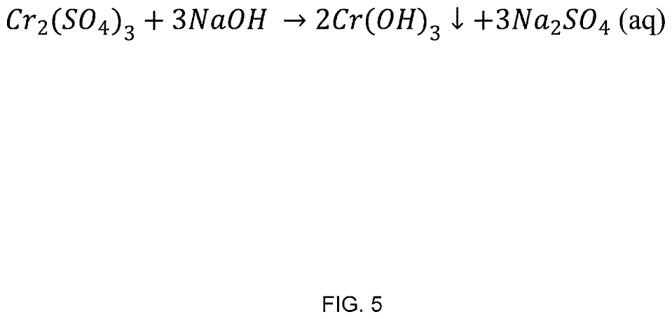

If desired, the Cr(III) may be further reduced. For example, referring to FIG. 5, after Cr(VI) is reduced to Cr(III), the Cr(III) may be further reduced. For example, sodium hydroxide may be used as a caustic. The sodium hydroxide may be mixed with Cr(III) to produce Cr(III) hydroxide and aqueous sodium sulfate. Other caustics may be used in other embodiments.

The various embodiments described herein thus represent a technical improvement to handling of Cr(VI) in COD testing. COD testing of wastewater may have environmental impacts with respect to the use of Cr(VI). Embodiments, provide a solution to detoxifying Cr(VI) in dichromate COD test vessels to Cr(III). In an embodiments, the reaction may form a precipitate from the solution, thereby reducing the risk of Cr(VI) entering the environment. Embodiments may provide a method that is both safer for personnel and cleaner for the environment. As the use of Cr(VI) comes under environmental and safety scrutiny, embodiments disclosed may provide an acceptable alternative to governments and regulatory agencies.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device, where the instructions are executed by a processor. In the context of this document, a storage device is not a signal and “non-transitory” includes all media except signal media.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and products according to various example embodiments. It will be understood that the actions and functionality may be implemented at least in part by program instructions. These program instructions may be provided to a processor of a device, e.g., a hand held measurement device such as illustrated in FIG. 1, or other programmable data processing device to produce a machine, such that the instructions, which execute via a processor of the device, implement the functions/acts specified.

It is noted that the values provided herein are to be construed to include equivalent values as indicated by use of the term “about.” The equivalent values will be evident to those having ordinary skill in the art, but at the least include values obtained by ordinary rounding of the last significant digit.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method for quenching hexavalent chromium, comprising:
obtaining a vessel comprising an aqueous sample comprising hexavalent chromium;
introducing a reducing agent to the aqueous sample; and
mixing, into a mixed solution, the reducing agent and the aqueous sample, wherein the mixing causes the reducing agent to quench the hexavalent chromium and wherein a quantity of the reducing agent comprises a quantity that reduces the hexavalent chromium to trivalent chromium.

2. The method of claim 1, further comprising introducing a caustic reagent to the vessel, wherein the caustic reagent mixes with the trivalent chromium precipitating chromium hydroxide.

3. The method of claim 1, wherein the quantity of the reducing agent comprises a quantity determined based upon a size of the vessel.

4. The method of claim 1, wherein the reducing agent comprises an aqueous solution.

5. The method of claim 1, wherein the reducing agent comprises a granular reducing agent.

6. The method of claim 1, wherein the reducing agent comprises a lyophilized reducing agent.

7. The method of claim 1, wherein the introducing a reducing agent comprises introducing a cap comprising the reducing agent to the vessel.

8. The method of claim 1, wherein the reducing agent is from a group consisting of ascorbic acid, hydrogen peroxide, sulfur dioxide, ferrous sulfate, and sodium metabisulfite.

9. The method of claim 1, wherein the mixing generates a colorimetric agent allowing for visualization of a reduction reaction.

10. The method of claim 9, further comprising identifying a completion of the reduction reaction based upon a color of the mixed solution.

11. A device, comprising:
a processor;
a memory device that stores instructions executable by the processor to:
obtain a vessel comprising an aqueous sample comprising hexavalent chromium;
introduce a reducing agent to the aqueous sample; and
mix, into a mixed solution, the reducing agent and the aqueous sample, wherein the mixing causes the reducing agent to quench the hexavalent chromium and wherein a quantity of the reducing agent comprises a quantity that reduces the hexavalent chromium to trivalent chromium.

12. The method of claim 11, further comprising introducing a caustic reagent to the vessel, wherein the caustic reagent mixes with the trivalent chromium precipitating chromium hydroxide.

13. The method of claim 11, wherein the quantity of the reducing agent comprises a quantity determined based upon a size of the vessel.

14. The method of claim 11, wherein the reducing agent comprises an aqueous solution.

15. The method of claim 11, wherein the reducing agent comprises a solid reducing agent.

16. The method of claim 11, wherein the introducing a reducing agent comprises introducing a cap comprising the reducing agent to the vessel.

17. The method of claim 11, wherein the reducing agent is from a group consisting of ascorbic acid, hydrogen peroxide, sulfur dioxide, ferrous sulfate, and sodium metabisulfite.

18. The method of claim 11, wherein the mixing generates a colorimetric agent allowing for visualization of a reduction reaction.

19. The method of claim 18, further comprising identifying a completion of the reduction reaction based upon a color of the mixed solution.

20. A product for quenching hexavalent chromium, comprising:
a storage device having code stored therewith, the code being executable by the processor and comprising:
code that obtains a vessel comprising an aqueous sample comprising hexavalent chromium;
code that introduces a reducing agent to the aqueous sample; and
code that mixes, into a mixed solution, the reducing agent and the aqueous sample, wherein the mixing causes the reducing agent to quench the hexavalent chromium and wherein a quantity of the reducing agent comprises a quantity that reduces the hexavalent chromium to trivalent chromium.
